(19) United States
(12) Patent Application Publication
(10) Pub. No.: US 2014/0251033 A1
(43) Pub. Date: Sep. 11, 2014

(54) SAMPLE TUBE HOLDER PROVIDING ZERO FORCE INSERTION OF SAMPLE TUBE

(71) Applicant: AGILENT TECHNOLOGIES, INC., Loveland, CO (US)

(72) Inventor: Seiji Unno, Loveland, CO (US)

(73) Assignee: AGILENT TECHNOLOGIES, INC., Loveland, CO (US)

(21) Appl. No.: 13/793,982

(22) Filed: Mar. 11, 2013

(51) Int. Cl. B01L 9/00

(52) U.S. Cl. CPC B01L 9/50
USPC 73/864.91

(57) ABSTRACT

An apparatus for holding a sample tube includes a plurality of rollers circumscribing a clearance space along a central axis, and an actuator configured for moving the rollers between a non-gripping position and a gripping position. At the non-gripping position, the rollers are oriented relative to the central axis such that a diameter of the clearance space is at a maximum; and at the gripping position, the rollers are at a twisted angle relative to the central axis, and the diameter is reduced such that the rollers contact the sample tube.

### TECHNICAL FIELD

The present invention relates generally to sample tube holders, and in particular to insertion of sample tubes into sample tube holders.

### BACKGROUND

Various applications involving the measurement or analysis of a fluid sample may require the sample to be held in a sample tube (or like container) and the sample tube to in turn be held in a sample tube holder. The sample tube may need to be centered precisely within a bore of the sample tube holder. Moreover, in applications involving high-throughput measurements or analyses, one or more procedural steps may be automated to reduce the amount of user involvement. The process of inserting the sample tube into, and removing the sample tube from, the bore of the sample tube holder may be automated. It may be desirable to minimize the amount of force or contact imparted to the sample tube during insertion and removal, particularly if the sample tube is composed of a fragile material such as glass. One example is measurement based on nuclear magnetic resonance (NMR), which requires a sample to be held in a precise position relative to one or more radio frequency (RF) coils, and which may involve automated insertion and removal of the sample tube.

Previous solutions for holding and centering sample tubes have entailed the use of various types of structures that are brought into contact with the sample tube, such as vertical support bars, plastic balls captured between the sample tube and o-rings, alignment bearings, and elastic blades. Such solutions may require the sample tube to be forced into contact with the structures during insertion. Some of the structures utilize soft materials that may permanently stick to the sample tube. Some of the structures have complex geometries and are expensive to manufacture.

Therefore, there is a need for systems, devices and methods for inserting a sample tube into a sample tube holder without imparting force on the sample tube, and for accurately centering the sample tube in the sample tube holder.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, an apparatus for holding a sample tube includes: a body comprising a bore for receiving the sample tube, the bore extending along a central axis; a plurality of rollers circumferentially spaced about the central axis and circumscribing a clearance space along the central axis; and an actuator configured for moving the rollers between a non-gripping position and a gripping position. Each roller extends along and is rotatable about a respective roller axis. At the non-gripping position, the rollers are oriented relative to the central axis such that a diameter of the clearance space is at a maximum; and at the gripping position, the rollers are at a twisted angle relative to the central axis, and the diameter is reduced such that the rollers contact the sample tube.

In some embodiments, the apparatus is configured as a sample spinner for nuclear magnetic resonance (NMR) applications.

According to another embodiment, an NMR probe includes: the apparatus for holding a sample tube; and an RF coil surrounding the apparatus.

According to another embodiment, a method for loading a sample tube into a sample tube holder includes: inserting the sample tube through a bore of the sample tube holder; and moving a plurality of rollers to a gripping position at which the rollers are at a twisted angle relative to the bore and the rollers contact the sample tube.

According to another embodiment, a sample tube holder is configured for performing any of the methods disclosed herein.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is an exploded view of an example of an apparatus for holding a sample tube according to some embodiments.

FIG. 2 is a cross-sectional elevation view of the apparatus illustrated in FIG. 1 when assembled, and also illustrating a sample tube inserted into the apparatus.

FIG. 3A is a top view of the apparatus illustrated in FIGS. 1 and 2 with a cap thereof removed, while the apparatus in a gripping position.

FIG. 3B is a top view similar to FIG. 3A, while the apparatus in a non-gripping position.

FIG. 4A is cut-away view of an upper region of the apparatus illustrated in FIGS. 1 and 2, while the apparatus is in the gripping position.

FIG. 4B is cut-away view similar to FIG. 4A, while the apparatus is in the non-gripping position.

FIG. 5 is a schematic diagram illustrating an example of calculating a radial distance x through which each roller of the apparatus moves from the non-gripping position to the gripping position.

FIG. 6 is a schematic view of an example of a nuclear magnetic resonance (NMR) spectrometer in which the apparatus may operate according to some embodiments.

### DETAILED DESCRIPTION

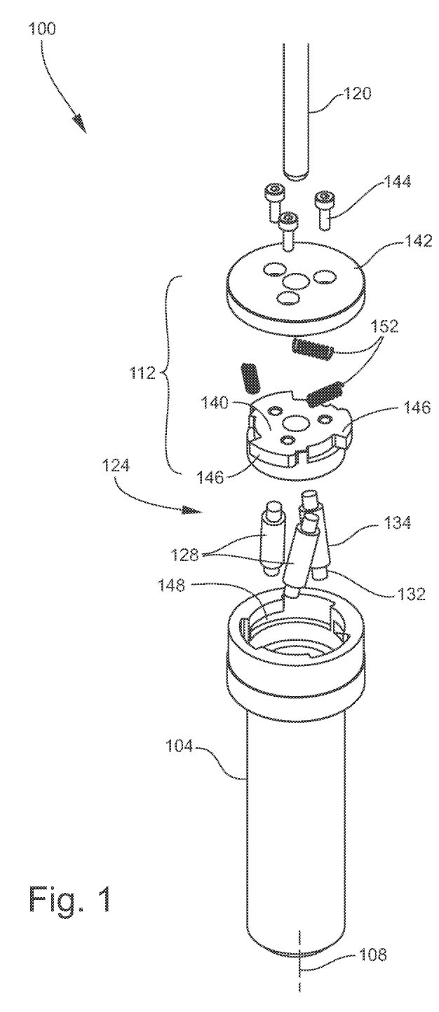

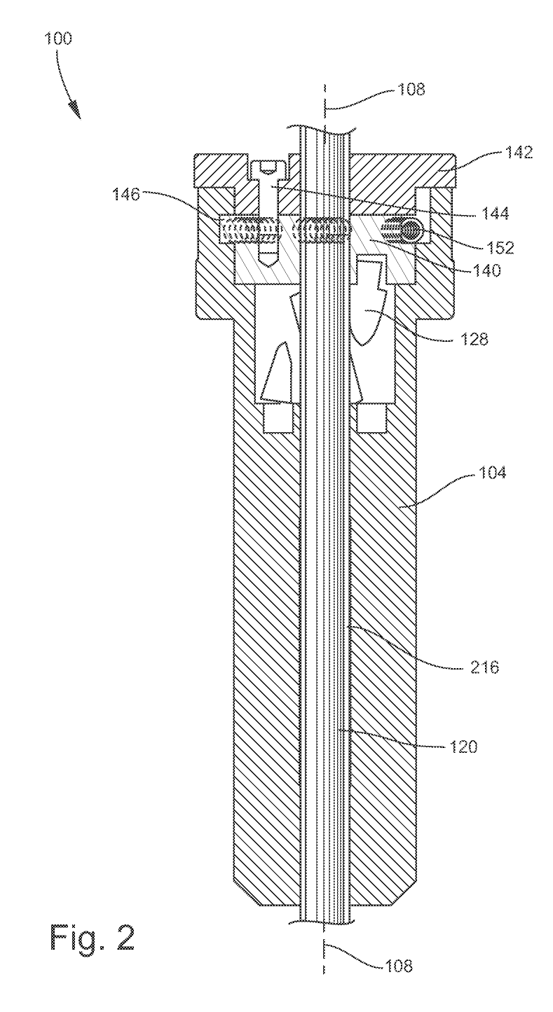

FIG. 1 is an exploded view of an example of an apparatus (or sample tube holder) 100 for holding a sample tube 120 according to some embodiments. FIG. 2 is a cross-sectional elevation view of the apparatus 100 when assembled. The apparatus 100 generally includes a main body or housing 104 elongated along a central axis 108 of the apparatus 100, an actuator 112, a bore 216 extending along the central axis 108, and a gripping device 124. The sample tube 120 is insertable through the bore 216. In some embodiments, the bore 216 has a diameter on the order of millimeters, for example 3 mm or 5 mm. In some embodiments, the bore 216 extends through the entire axial length of the apparatus 100. In some embodiments, the actuator 112 is located at an upper region of the apparatus 100. The actuator 112 is generally movable between a non-gripping position and a gripping position to in turn move the gripping device 124 between a non-gripping position and a gripping position, as described further below. In some embodiments, the actuator 112 is rotatable about the central axis 108 between the non-gripping position and the gripping position, and the bore 216 passes through the actuator 112.

Generally, the sample tube 120 may be any container adapted for holding a fluid sample to be tested or measured by an instrument. In some embodiments the apparatus 100 is, or is part of, a sample probe utilized in nuclear magnetic resonance (NMR) measurements (e.g., NMR spectrometry), in which case the sample tube 120 is adapted for containing a sample comprising NMR-active nuclei. In some embodiments, the sample tube 120 has an outside diameter on the millimeter scale (e.g., 3 mm or 5 mm), and a length ranging from 100 mm to 200 mm. In some embodiments, the sample tube 120 is composed of glass. The apparatus 100 may be adapted for manual or automated insertion and removal of the sample tube 120. Automated insertion and removal may be performed by, for example, a gripping device (e.g., the end effector of a robot). Alternatively or additionally, automated insertion and removal may be assisted by pneumatics, in which case the bore 216 may be coupled into a pneumatic circuit.

In some embodiments, the apparatus 100 may be configured as a turbine, or sample spinner, such as may be utilized in NMR applications. In this case, the apparatus 100 may spin the sample tube 120 while it is securely held in the bore 216. The apparatus 100 may include one or more turbine surfaces for this purpose. In some embodiments, the turbine surfaces may a smooth circular surface, such as an outer surface of the body 104, which is driven to spin about the central axis 108 by air surface friction. In other embodiments, the turbine surfaces may be shaped (e.g., vanes, blades, etc., not shown) so as to be responsive to impact by a gas flow to drive the rotation of the apparatus 100 about the central axis 108, relative to a stator (not shown) and with gas and/or solid bearings provided, as appreciated by persons skilled in the art. Such turbine surfaces may be located anywhere on the apparatus 100.

Generally, the gripping device 124 is configured for holding the sample tube 120 in a fixed axial position, or operating position, after the sample tube 120 has been inserted into the bore 216 to the operating position. The gripping device 124 is coupled to, or otherwise communicates with, the actuator 112 so as to be movable by the actuator 112 between the non-gripping position and the gripping position. At the non-gripping position, the sample tube 120 is free to move axially through the bore 216 during insertion or removal without encountering any forces that might impair its movement or damage it. At the gripping position, the sample tube 120 is fixed in place by the gripping device 124 at which time the sample tube 120 is ready for its intended use. The gripping position thus corresponds to the operating position of the sample tube 120.

In the illustrated embodiment, the gripping device 124 includes a plurality of rollers 128. By example, FIG. 1 illustrates three rollers 128 circumferentially spaced 120 degrees apart from each other about the central axis 108. In other embodiments less or more than three rollers 128 may be provided. Each roller 128 is elongated along a central roller axis about which the roller 128 is rotatable. Each roller 128 may include a central rod or core 132 coaxially surrounded by a sleeve 134. The rod 132 may be composed of a low-cost material such as, for example, fiberglass. The sleeve 134, or at least the outer surface thereof, may be composed of a frictional material, i.e., a material that enhances the ability of the roller 128 to grip or prevent slippage of the sample tube 120 upon coming into contact with the sample tube 120. The sleeve material may or may not be deformable, and if deformable may only be slightly deformable. For example, the sleeve 134 may be composed of a hard rubber or a hard plastic such as nylon. In some implementations, a hard rubber or plastic may be preferred over other materials such as soft rubber as a hard material will not stick to the sample tube 120, particularly in a typical embodiment in which the sample tube 120 is made of glass. As will become evident from the present description, the rollers 128 are able to grip the sample tube 120 in an effective manner that does not require the use of deformable materials.

In the illustrated embodiment, the actuator 112 includes an actuator body 140 and an actuator cap 142 secured to the actuator body 140 by suitable fasteners 144. The actuator body 140 may include one or more radially outwardly protruding tabs 146. After assembly, the tabs 146 are positioned in one or more internal grooves or channels 148 of the main body 104, which guide the movement of the actuator 112. The actuator 112 may be moved (rotated in the present embodiment) manually or by automation. In automated embodiments, the actuator 112 may be configured to be manipulated (e.g., gripped and rotated) by a robotic end effector, such as a pair of fingers as appreciated by persons skilled in the art. In some embodiments, the actuator 112 and thus the rollers 128 may be biased by a spring mechanism toward the gripping position. In this case, prior to insertion of the sample tube 120, the actuator 112 is rotated to the non-gripping position against the biasing force(s), and after insertion is released whereby the rollers 128 are urged into the gripping position. In the illustrated embodiment, the biasing force is provided by one or more springs 152 positioned in respective recesses formed between one or more outer surfaces of the actuator body 140 and one or more inner surfaces of the main body 104.

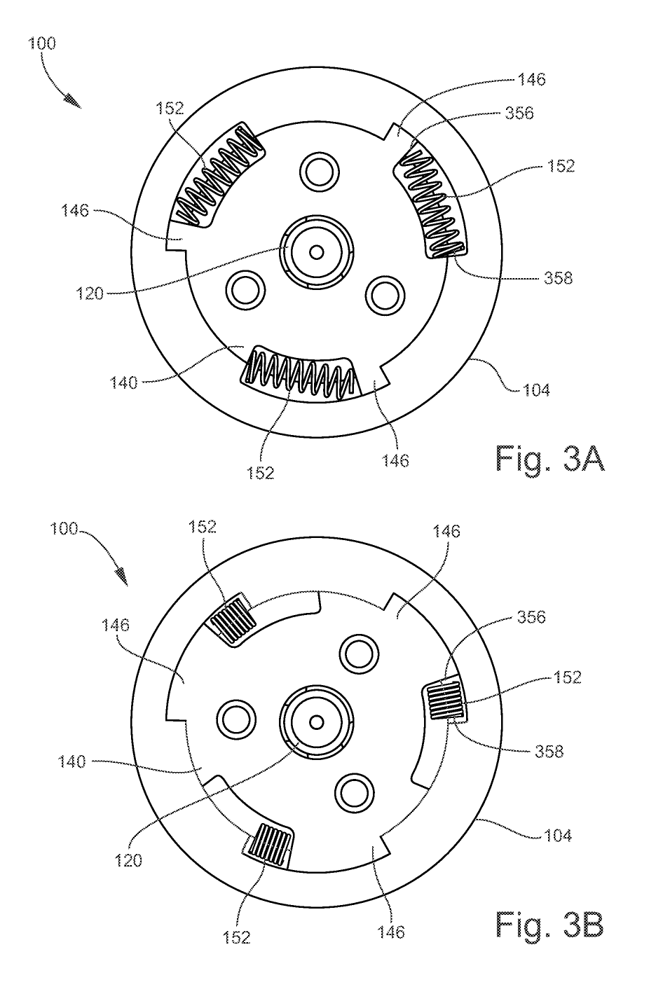

FIGS. 3A and 3B are top views of the apparatus 100 with the actuator cap 142 removed, while the apparatus 100 is in the gripping position and non-gripping position, respectively. Each spring 152 is retained between a surface 356 of a corresponding tab 146 and a surface 358 of the main body 104. In this example, the actuator body 140 rotates clockwise from the gripping position (FIG. 3A) to the non-gripping position (FIG. 3B), and the springs 152 are compressed by the corresponding rotation of the tab surfaces 356.

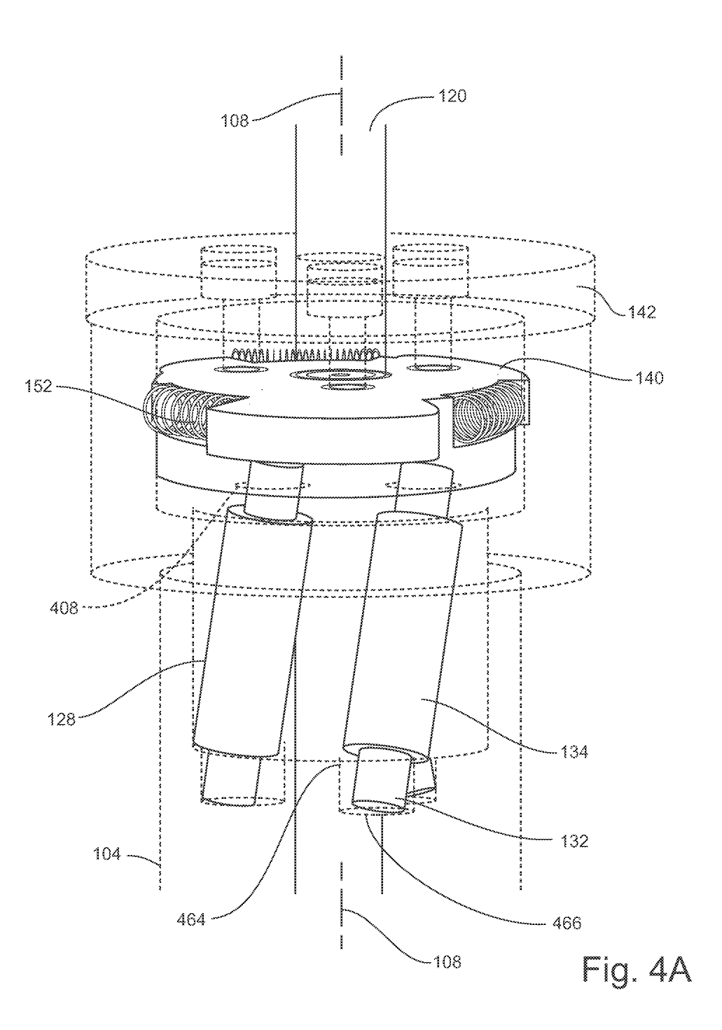

FIGS. 4A and 4B are cut-away views of an upper region of the apparatus 100, while the apparatus 100 is in the gripping position and non-gripping position, respectively. At the gripping position, the rollers 128 (or the roller axes) are oriented at a twisted angle relative to the central axis 108. In the present context, the term “twisted angle” generally means that the rollers 128 are tilted relative to the central axis 108, and are all tilted in the same direction or “sense” (clockwise or counterclockwise) as one conceptually moves in a circle around the central axis 108. As illustrated in FIG. 4B, in some embodiments the rollers 128 may be parallel (e.g., vertical) or substantially parallel (e.g., angled by a small amount relative to the central axis 108, such as up to ten degrees) with the central axis 108 when at the non-gripping position. This, however, is not a requirement. More generally, the rollers 128 may be oriented at any twisted angle (which may be zero) at the non-gripping position that is smaller than the twisted angle at the gripping position.

The rollers 128 collectively circumscribe a cylindrical clearance space 462 (FIG. 4B) at the non-gripping position sufficient for free movement of the sample tube 120. The clearance space 462 is concentric with the bore 216, and at the non-gripping position is of greater diameter than the bore 216. The diametrical tolerance between the bore 216 and sample tube 120 is not critical, so long as the sample tube 120 is free to move axially through the bore 216 during insertion and removal (and while the apparatus 100 is at the non-gripping position). Actuation of the rollers 128 from the non-gripping position to the gripping position reduces the diameter of the clearance space 462 until the rollers 128 come into contact with the sample tube 120. At this gripping position, the sample tube 120 is securely fixed in place such that it cannot move axially. Moreover, with multiple rollers 128 circumferentially spaced from each other, particularly with equal spacing, the rollers 128 at the gripping position may apply equal forces to the sample tube 120 and accurately center the sample tube 120 in the bore 216.

Generally, the rollers 128 may be mounted or supported in the main body 104, and may communicate with the actuator 112, by any means suitable for enabling movement between the gripping position and the non-gripping position. In the illustrated embodiment, the main body 104 includes a plurality of mounting holes 464 for receiving the lower ends of the respective rollers 128. For example, the mounting holes 464 may be sized such that the rods 132 extend through the mounting holes 464 while the sleeves 134 rest on surfaces surrounding the mounting holes 464. The mounting holes 464 may be openings leading into receptacles 466 in which the lower ends are seated. The mounting holes 464 may be shaped so as to facilitate the change in orientation of the rollers 128 to the twisted angle position. Thus, for example, the shape of the mounting holes 464 may be elliptical, oval, racetrack-shaped, lobed, etc. The shape may be generally in the nature of a slot, which may be a rounded slot as in the foregoing examples. The predominant dimension of the slot may follow a tangential path or an arcuate path relative to the bore 216.

Also in the illustrated embodiment, the actuator body 140 includes a plurality of mounting holes 468 for receiving the upper ends of the respective rollers 128. For example, the mounting holes 468 may be sized such that the rods 132 extend through the mounting holes 468 while the sleeves 134 remain below the mounting holes 468 with or without contacting surfaces surrounding the mounting holes 468. The mounting holes 468 may be shaped so as to facilitate guiding the movement of the rollers 128 from the non-gripping position to the gripping position. The mounting holes 468 may have a shape such as described above in conjunction with the mounting holes 464 of the main body 104.

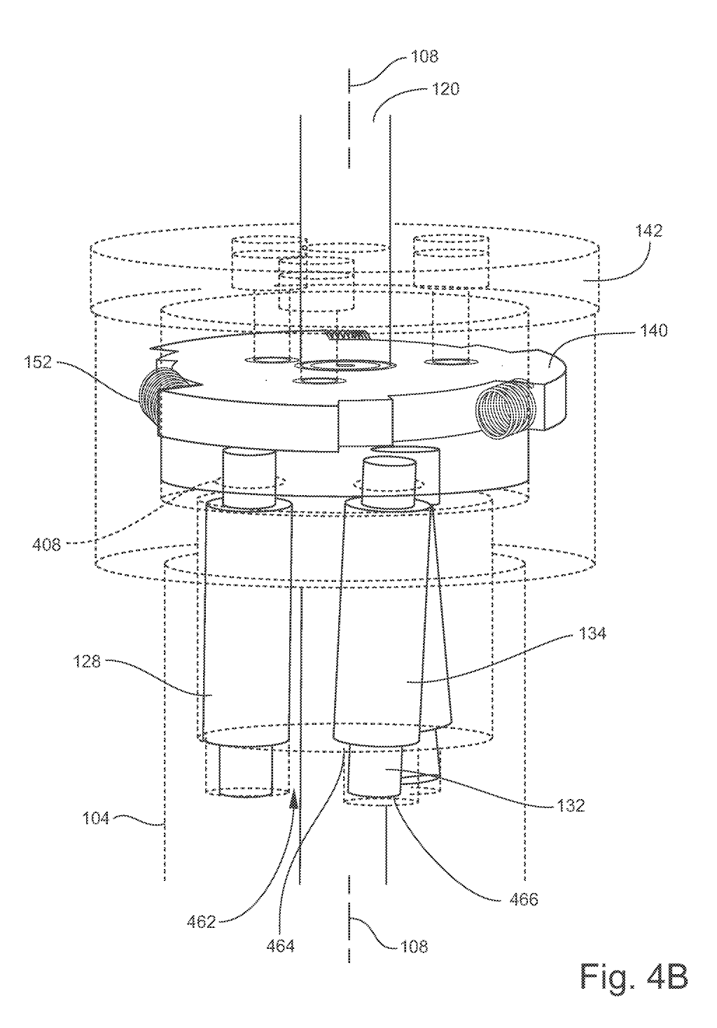

FIG. 5 is a schematic diagram illustrating an example of calculating the radial distance x through which each roller 128 moves from the non-gripping position to the gripping position. A radius r of a circle corresponds to the distance from the central axis 108 of the bore 216 to the outside surface of the roller 128. The roller 128 moves from point A (non-gripping position) to point B (gripping position) through an angle a as seen from the top of the apparatus 100. The distance x may be calculated from the relation x=r−r (cos α). Thus, for example, when α=30°, x=r−r (0.866)=0.134 r.

An example of operating the apparatus 100 will now be described. Prior to inserting the sample tube 120, the actuator 112 is operated (manually or automatically) to place the apparatus 100 in the non-gripping position. The sample tube 120 is then inserted (manually or automatically) into the bore 216 until the sample tube 120 reaches a desired operating position within the bore 216, for example, at a desired elevation relative to the device that is to carry out measurement or detection operation on a sample contained in the sample tube 120. The actuator 112 is then operated to place the apparatus 100 in the gripping position. At this position, the rollers 128 have moved to the twisted angle at which they hold the sample tube 120 securely in the operating position and accurately centered in the bore 216. As described above, moving the actuator 112 to the gripping position may entail simply releasing the actuator 112 such that the rollers 128 move to the gripping position under the influence of a spring force or forces. After carrying out the desired operation on the sample, the sample tube 120 may be removed from the apparatus 100, by operating the actuator 112 to move the rollers 128 back to the non-gripping position and then removing the sample tube 120 from the bore 216. Prior to moving the rollers 128 back to the non-gripping position, if necessary the sample tube 120 may be held in place (manually or automatically) in preparation for removing it from the apparatus 100.

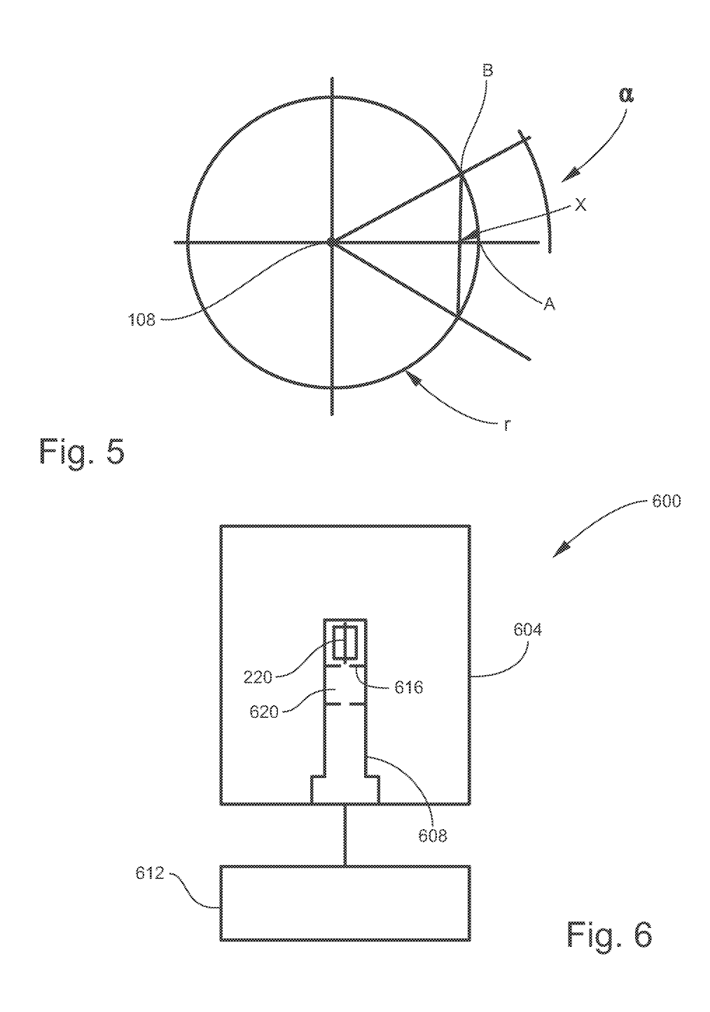

FIG. 6 illustrates one non-limiting example of an operating environment for the sample tube 120 and apparatus 100. Specifically, FIG. 6 is a schematic view of an example of a nuclear magnetic resonance (NMR) spectrometer 600. Generally, the structure and operation of NMR instruments are understood by persons skilled in the art, and thus the NMR spectrometer 600 will be just briefly described herein. The NMR spectrometer 600 generally includes a (typically superconducting) magnet 604 for applying a static magnetic B₀ field, an NMR probe 608 disposed in a bore of the magnet 604, and a control/acquisition system 612 in signal communication with the magnet 604 and the NMR probe 608. The apparatus 100 described above may correspond to, be part of, or be loaded into the NMR probe 608. The NMR probe 608 includes one or more radio frequency (RF) sample coils 616 and an NMR probe circuit assembly 620 in signal communication with the sample coil(s) 616. In operation, the sample tube 120 containing the sample to be irradiated is inserted in the apparatus 100 as such that the sample tube 120 is coaxially surrounded by the sample coil(s) 616. The probe circuit assembly 620 is utilized for transmitting RF excitation signals (periodic magnetic B₁ fields) to the sample coil(s) 616 and receiving RF measurement signals (NMR response signals) from the sample coil(s) 616. The control/acquisition system 612 is configured for controlling the RF transmit/receive operations, conditioning and processing the RF measurement signals, and producing frequency-domain NMR spectra therefrom.

As appreciated by persons skilled in the art and as noted earlier in this description, in some embodiments the apparatus 100 may be configured as a turbine, or sample spinner, in which case the apparatus 100 may spin the sample tube 120 at a high angular velocity about the central axis to reduce the effects of inhomogeneities in the sample during measurements. A portion of the NMR probe 608 shown in FIG. 6 may serve as the stator relative to which the apparatus 100 (i.e., the rotor) spins.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. An apparatus for holding a sample tube, the apparatus comprising:
a body comprising a bore for receiving the sample tube, the bore extending along a central axis;
a plurality of rollers circumferentially spaced about the central axis and circumscribing a clearance space along the central axis, wherein:
each roller extends along and is rotatable about a respective roller axis;
the rollers are movable between a non-gripping position and a gripping position;
at the non-gripping position, the rollers are oriented relative to the central axis such that a diameter of the clearance space is at a maximum; and
at the gripping position, the rollers are at a twisted angle relative to the central axis, and the diameter is reduced such that the rollers contact the sample tube; and
an actuator configured for moving the rollers between the non-gripping position and the gripping position.

2. The apparatus of claim 1, comprising a spring mechanism configured for biasing the rollers to the gripping position.

3. The apparatus of claim 2, wherein the spring mechanism comprises spring positioned between the actuator and the body, and wherein movement of the actuator compresses the spring.

4. The apparatus of claim 1, wherein the body comprises a groove, and the actuator comprises a tab movable in the groove.

5. The apparatus of claim 4, wherein the body comprises an inside surface, and further comprising a spring positioned between the inside surface and the tab, wherein movement of the tab compresses the spring against the inside surface.

6. The apparatus of claim 1, wherein at the non-gripping position the rollers are substantially parallel with the central axis.

7. The apparatus of claim 1, wherein each roller comprises a rod and a sleeve surrounding the rod, wherein the sleeve is composed of a frictional material.

8. The apparatus of claim 1, wherein the actuator is rotatable about the central axis.

9. The apparatus of claim 1, wherein the body comprises a plurality of mounting holes in which respective lower ends of the rollers extend, wherein the actuator is coupled to upper ends of the rollers and is rotatable about the central axis.

10. The apparatus of claim 9, wherein the mounting holes have a non-circular shape configured for facilitating tilting of the rollers during movement between the non-gripping position and the gripping position.

11. The apparatus of claim 1, wherein the actuator comprises a plurality of mounting holes in which respective upper ends of the rollers extend.

12. The apparatus of claim 1, comprising a turbine surface configured for spinning the apparatus about the central axis in response to a gas flow.

13. A nuclear magnetic resonance (NMR) probe, comprising:
the apparatus of claim 1; and
an RF coil surrounding the apparatus.

14. A method for loading a sample tube into a sample tube holder, the method comprising:
inserting the sample tube through a bore of the sample tube holder; and
moving a plurality of rollers to a gripping position at which the rollers are at a twisted angle relative to the bore and the rollers contact the sample tube.

15. The method of claim 14, wherein inserting the sample tube is done without imparting any force to the sample tube prior to moving the rollers to the gripping position.

16. The method of claim 14, wherein moving the rollers to the gripping position centers the sample tube in the bore.

17. The method of claim 14, wherein the rollers circumscribe a clearance space aligned with the bore, inserting the sample tube is done while the rollers are at a non-gripping position at which a diameter of the clearance space is greater than an outer diameter of the sample tube, and the rollers are moved to the gripping position from the non-gripping position such that the diameter of the clearance space is reduced.

18. The method of claim 14, wherein the rollers are biased toward the gripping position, and further comprising, prior to inserting the sample tube, moving the rollers against the bias to a non-gripping position that provides clearance for the sample tube to be inserted.

19. The method of claim 14, wherein moving the rollers comprises operating an actuator communicating with the rollers.

20. The method of claim 14, comprising, while moving the rollers, guiding the rollers by rotating an actuator coupled to the rollers.
